(19) United States
(12) Patent Application Publication
(10) Pub. No.: US 2014/0340620 A1
(43) Pub. Date: Nov. 20, 2014

(54) COLOR FILTER, METHOD FOR PRODUCING THE SAME, AND DISPLAY APPARATUS

(71) Applicants: BOE Technology Group Co., LTD., Beijing (CN); Beijing BOE Display Technology Co., LTD., Beijing (CN)

(72) Inventors: Hongshu Zhang, Beijing (CN); Xibin Shao, Beijing (CN)

(73) Assignees: BOE Technology Group Co., LTD., Beijing (CN); Beijing BOE Display Technology Co., LTD., Beijing (CN)

(21) Appl. No.: 14/225,772

(22) Filed: Mar. 26, 2014

(30) Foreign Application Priority Data
May 15, 2013 (CN) 201320265289.0

(51) Int. Cl. G02F 1/1335; G02B 5/28

(52) U.S. Cl. CPC G02F 1/133514; G02B 5/285; G02F 1/133516; G02F 2001/133521
USPC 349/105; 359/583; 29/428

(57) ABSTRACT

A color filter, comprising: a substrate; a plurality of first pixel regions, a plurality of second pixel regions and a plurality of third pixel regions defined on a first side of the substrate; and a band pass filter layer comprising a first medium sub layer, a second medium sub layer and a third medium sub layer successively formed on a second side of the substrate or on the plurality of first pixel regions, the plurality of second pixel regions and the plurality of third pixel regions, wherein the second medium sub layer has a first thickness in a first medium area corresponding to the first pixel region, a second thickness in a second medium area corresponding to the second pixel region and a third thickness in a third medium area corresponding to the third pixel region. The present invention also relates to a method for manufacturing the color filter. The color filter filters the light with the band pass filter layer of a fabryperot type, thereby, the light beam having not been transmitted through is reflected back to be utilized again, increasing the utilization of the light.

### CROSS-REFERENCE TO RELATED APPLICATION

This application claims the benefit of Chinese Patent Application No. 201320265289.0 filed on May 15, 2013 in the State Intellectual Property Office of China, the whole disclosure of which is incorporated herein by reference.

### BACKGROUND OF THE INVENTION

1. Field of the Invention

The present invention relates to a liquid crystal display, more particularly, relates to a color filter, a method for producing the color filter, as well as a display apparatus comprising the color filter.

2. Description of the Related Art

A color filter for displaying a colorful image is a main component of a liquid crystal display. In prior arts, as shown in FIG. 1, the color filter of the liquid crystal display comprises a substrate 10 on which a plurality of pixel regions 30 defined by a black matrix 20. The pixel regions 30 correspond to pixel units on an array substrate. Filter layers having different colors, generally comprising a red filter layer 40′(R), a green filter layer 50′(G) and a blue filter layer 60′(B), are provided in the pixel regions 30. A flat layer (or a protection layer) 102 is provided above the filter layer. In a Twisted Nematic (TN) liquid crystal display, a transparent conductive layer 70 is provided on the flat layer 102 as a common electrode.

So far, the color filter of the liquid crystal display generally is a color blocking type filter. The color blocking type filter absorbs a light beam to achieve a light-filtering function. However, the color blocking type filter decreases the utilization of incident light, and only about 30% of incident light is utilized.

### SUMMARY OF THE INVENTION

The present invention has been made to overcome or alleviate at least one aspect of the above mentioned disadvantages.

Accordingly, it is an object of the present invention to provide a color filter, in which a light is filtered with a band pass filter layer of a fabryperot type, and a light beam having not been transmitted through is reflected back to be utilized again so as to increase the utilization of the light.

Accordingly, it is another object of the present invention to provide a display apparatus that displays a colorful image with the above color filter so as to increase the utilization of the light.

According to an aspect of the present invention, there is provided a color filter, comprising:

a substrate;

a plurality of first pixel regions, a plurality of second pixel regions and a plurality of third pixel regions defined on a first side of the substrate; and

a band pass filter layer comprising a first medium sub layer, a second medium sub layer and a third medium sub layer successively formed on a second side of the substrate or on the plurality of first pixel regions, the plurality of second pixel regions and the plurality of third pixel regions,

wherein the second medium sub layer has a first thickness in a first medium area corresponding to the first pixel region, a second thickness in a second medium area corresponding to the second pixel region and a third thickness in a third medium area corresponding to the third pixel region.

According to another aspect of the present invention, there is provided a display apparatus comprising a color filter according to the above embodiment.

According to another aspect of the present invention, there is provided a method for producing a color filter, comprising:

providing a substrate on a first side of which a plurality of first pixel regions, a plurality of second pixel regions and a plurality of third pixel regions are defined;

forming a first medium sub layer on a second side of the substrate or on the plurality of first pixel regions, the plurality of second pixel regions and the plurality of third pixel regions;

forming a second medium sub layer on the first medium sub layer, wherein the second medium sub layer has a first medium area, a second medium area and a third medium area corresponding to the first pixel region, the second pixel region and the third pixel region, respectively, and the first, second and third medium areas are different from each other in thickness; and

forming a third medium sub layer on the second medium sub layer having the first, second and third medium areas.

In the above embodiments of the present invention, the color filter filters the light with the band pass filter layer of a fabryperot type, thereby, the light beam having not been transmitted through is reflected back to be utilized again, increasing the utilization of the light.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative cross section view of a color filter of a liquid crystal display in prior arts;

FIG. 2 is an illustrative cross section view of a color filter according to a first exemplary embodiment of the present invention;

FIGS. 3-7 are illustrative views showing a process of producing the color filter shown in FIG. 2;

FIG. 8 is an illustrative cross section view of a color filter according to a second exemplary embodiment of the present invention;

FIG. 9 is an illustrative cross section view of a display apparatus according to a first exemplary embodiment of the present invention; and

FIG. 10 is an illustrative cross section view of a display apparatus according to a second exemplary embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In prior arts, a color filter of a liquid crystal display generally is a color blocking type (absorbing type) filter. The color blocking type filter absorbs a light beam to achieve a light-filtering function. However, the color blocking type filter decreases the utilization of the light. In order to overcome or alleviate the disadvantage in prior arts, the present invention provides a color filter to increase the utilization of the light.

Generally, a band pass filter layer may separate a homogeneous light having a certain waveband out of a compound light. When a light beam is irradiated on the band pass filter layer, only a component of the light beam within the certain waveband is transmitted therethrough, and a component of the light within a waveband other than the certain waveband is reflected. Generally, there are two different structure types of band pass filter layers available in market. As for the first structure type, the pass band of the band pass filter layer is an overlapping pass band consisting of a long wave pass layer and a short wave pass layer. However, the first structure type of band pass filter layer cannot obtain a narrow pass band, and cannot be used as the color filter of the liquid crystal display. As for the second structure type, a filter layer of a fabryperot interferometer type is used. The filter layer of a fabryperot interferometer type comprises a first medium sub layer, a second medium sub layer and third medium sub layer. The first and third medium sub layers are coated on opposite sides of the second medium sub layer. The transmissivity of the light beam is related to the thickness of the second medium sub layer, that is, the thicknesses of the second medium sub layer corresponding to different waves of light beams are different. The filter layer of a fabryperot interferometer type can obtain a narrow pass band, and can be used as the color filter of the liquid crystal display. The color filter described herein according to various embodiments of the present invention comprises the filter layer of a fabryperot interferometer type.

According to a general concept of the present invention, there is provided a color filter, comprising: a substrate; a plurality of first pixel regions, a plurality of second pixel regions and a plurality of third pixel regions defined on a first side of the substrate; and a band pass filter layer comprising a first medium sub layer, a second medium sub layer and a third medium sub layer successively formed on a second side of the substrate or on the plurality of first pixel regions, the plurality of second pixel regions and the plurality of third pixel regions. The second medium sub layer has a first thickness in a first medium area corresponding to the first pixel region, a second thickness in a second medium area corresponding to the second pixel region and a third thickness in a third medium area corresponding to the third pixel region.

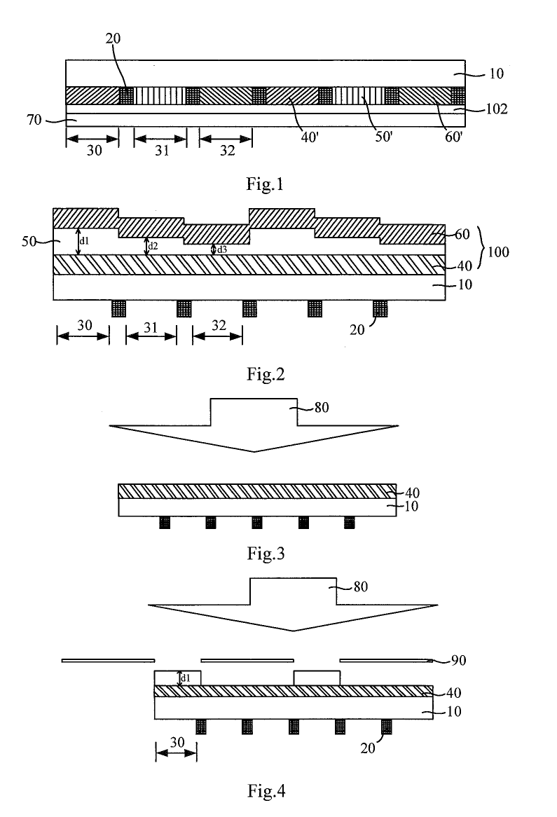

FIG. 2 is an illustrative cross section view of a color filter according to a first exemplary embodiment of the present invention.

As shown in FIG. 2, the color filter according to the first exemplary embodiment of the present invention comprises a substrate 10, for example, a transparent glass substrate, a quartz substrate or a transparent polymer substrate. A plurality of first pixel regions 30, a plurality of second pixel regions 31 and a plurality of third pixel regions 32 are defined on a first side (a lower side in FIG. 2) of the substrate 10 by a black matrix 20. Each of the pixel regions corresponds to a respective pixel unit on an array substrate of the liquid crystal display. Also, a filter layer for achieving the display of colorful image is formed on the substrate 10. The filter layer permits only a light beam having a wave length within a predetermined wave length to be transmitted therethrough, and reflects back a light beam having a wave length beyond the predetermined wave length to reuse it, increasing the utilization of the light.

In an exemplary embodiment, as shown in FIG. 2, the filter layer may be a band pass filter layer 100 formed on a second side (an upper side in FIG. 2) of the substrate 10. The band pass filter layer 100 comprises a first medium sub layer 40, a second medium sub layer 50 and a third medium sub layer 60 successively formed on the substrate 10. After a light from a back light source (not shown) of the liquid crystal display enters into the first medium sub layer 40, a part of the light is reflected back onto a reflection plate of the back light source of the liquid crystal display, and utilized again, increasing the utilization of the light. The other part of light enters into the second medium sub layer 50. The thickness of the second medium sub layer 50 is controlled so that only a light beam of the other part of light with a wave length within a predetermined waveband can be transmitted through and exits from the third medium sub layer 60. The predetermined waveband is very narrow to ensure the color resolution and quality of the liquid crystal display. A light beam with a wave length within a waveband other than the narrow predetermined waveband is reflected back onto the reflection plate of the back light source of the liquid crystal display and utilized again, further increasing the utilization of the light from the back light source. The utilization of the light can be increased to about 50% by means of the color filter of the present invention.

Generally, the liquid crystal display achieves the colorful image display with three primary colors (Red, Green and Blue). Correspondingly, the second medium sub layer 50 has a first thickness d1 in a first medium area corresponding to the first pixel region 30, so as to permit only Red light to be transmitted therethrough and reflect light having a wave length beyond that of Red light. The second medium sub layer 50 has a second thickness d2 in a second medium area corresponding to the second pixel region 31, so as to permit only Green light to be transmitted therethrough and reflect light having a wave length beyond that of Green light. The third medium sub layer 50 has a third thickness d3 in a third medium area corresponding to the third pixel region 32, so as to permit only Blue light to be transmitted therethrough and reflect light having a wave length beyond that of Blue light.

In an exemplary embodiment, the thickness d of the medium area of the second medium sub layer 50 corresponding to the respective pixel region can be calculated by the following expression:

$$d = \frac{m * λ}{2 n} \qquad ( 1 )$$

wherein,

m is an odd number, when m is less, the calculated thickness d becomes less, and the light transmissivity becomes better;

λ is the wave length of the light permitted to be transmitted through the respective pixel region;

n is the refractive index of the second medium sub layer 50.

In an exemplary embodiment of the present invention, the first medium sub layer 40 and the third medium sub layer 60 may be made of the same material, for example, the material may comprise but not limited to, metal, alloy or metallic oxide. In an exemplary embodiment, the first medium sub layer 40 and the third medium sub layer 60 may be made of silver, silver alloy, Indium Tin Oxide (ITO) or Indium Zinc Oxide (IZO), so as to ensure that the transmission spectrum of the color filter is symmetrical and has a single wave crest.

In another exemplary embodiment, the first medium sub layer 40 and the third medium sub layer 60 may be configured to have the same thickness, so as to further ensure that the transmission spectrum of the color filter is symmetrical and has a single wave crest.

In order to ensure an enough light transmission, the first medium sub layer 40 and the third medium sub layer 60 may have a thin thickness of, for example, 20 nm˜100 nm, preferably, 40 nm.

In an exemplary embodiment of the present invention, the band pass filter layer 100 and the black matrix 20 may be formed respectively on opposite sides of the substrate 10, that is, on the first and second sides, as shown in FIG. 2.

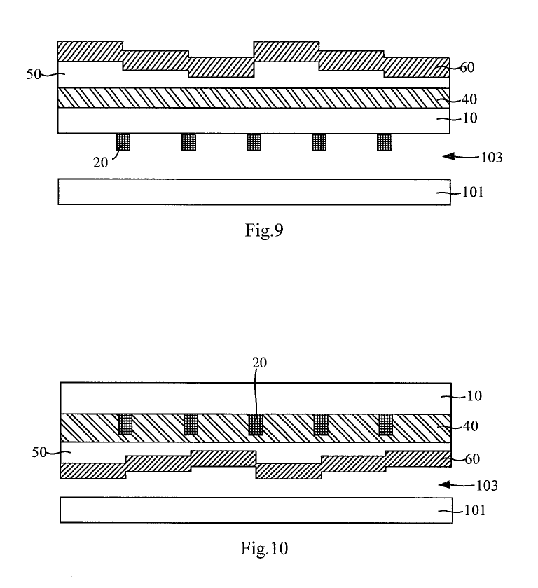

FIG. 9 is an illustrative cross section view of a display apparatus according to a first exemplary embodiment of the present invention.

As shown in FIG. 9, the display apparatus is a liquid crystal display of an Advanced Super Dimension Switch (ADS) type, comprising the color filter of FIG. 2.

In an exemplary embodiment, as shown in FIGS. 2 and 9, the first pixel region 30, the second pixel region 31 and the third pixel region 32 are formed on the first side of the substrate 10. A liquid crystal layer 103 is formed on the first, second and third pixel regions 30, 31 and 32. An ITO layer 101 is formed on a side of the liquid crystal layer 103 opposite to the substrate 10 to cover the entire substrate 10. The ITO layer 101 may be used as an electromagnetic shielding layer to remove the static electricity. In an alternative embodiment, the ITO layer may be used as the first medium sub layer 40 without needing individually producing the first medium sub layer 40, simplifying the producing process, and reducing the cost of the display apparatus.

In another exemplary embodiment of the present invention, the band pass filter layer 100 and the black matrix 20 both are formed on the same side of the substrate 10, that is, on the first side of the second side, as shown in FIG. 8.

FIG. 10 is an illustrative cross section view of a display apparatus according to a second exemplary embodiment of the present invention.

As shown in FIG. 10, the display apparatus is a Twisted Nematic type of liquid crystal display comprising the color filter of FIG. 8.

In an exemplary embodiment, as shown in FIGS. 8 and 10, the first pixel region 30, the second pixel region 31 and the third pixel region 32 are formed on the first side or the second side of the substrate 10. The color filter is provided on the first, second and third pixel regions 30, 31 and 32. A liquid crystal layer 103 is provided on the third medium sub layer 60 of the color filter. An ITO layer 101 is formed on a side of the liquid crystal layer 103 opposite to the substrate 10. The ITO layer 101 is used as a common electrode. In an alternative exemplary embodiment, the third medium sub layer 60 of the color filter is made of metal (the first medium sub layer 40 also is made of metal), and the third medium sub layer 60 is used as the ITO layer without needing individually producing the ITO layer, simplifying the producing process, and reducing the cost of the display apparatus.

In an exemplary embodiment, the second medium sub layer 50 may be made of a dielectric material, for example, MgF₂, SiO₂, Si₃N₄ and TiO₂. In this case, the first medium sub layer 40 may be used as an electromagnetic shielding layer to remove the static electricity.

In a further exemplary embodiment, an upper polarizing filter or a protection layer (not shown) is provided on the third medium sub layer 60 far away from the substrate 10, so as to protect the third medium sub layer 60 from being oxidized.

According to another aspect of the present invention, there is provided a method for producing a color filter, comprising:

providing a substrate on a first side of which a plurality of first pixel regions, a plurality of second pixel regions and a plurality of third pixel regions are defined;

forming a first medium sub layer on a second side of the substrate or on the plurality of first pixel regions, the plurality of second pixel regions and the plurality of third pixel regions;

forming a second medium sub layer on the first medium sub layer, wherein the second medium sub layer has a first medium area, a second medium area and a third medium area corresponding to the first pixel region, the second pixel region and the third pixel region, respectively, and the first, second and third medium areas are different from each other in thickness; and

forming a third medium sub layer on the second medium sub layer having the first, second and third medium areas.

In an exemplary embodiment, in the above method, the first medium sub layer is deposited on the second side of the substrate or on the plurality of first pixel regions, the plurality of second pixel regions and the plurality of third pixel regions by a plasma enhanced chemical vapor deposition (PECVD) equipment. The first, second and third medium areas of the second medium sub layer are deposited on the first medium sub layer by the PECVD equipment with using a mask. During depositing the first, second and third medium areas of the second medium sub layer, by controlling the depositing time, the first, second and third medium areas are formed to have different thicknesses from each other. The third medium sub layer is deposited on the second medium sub layer having the first, second and third medium areas by the PECVD equipment.

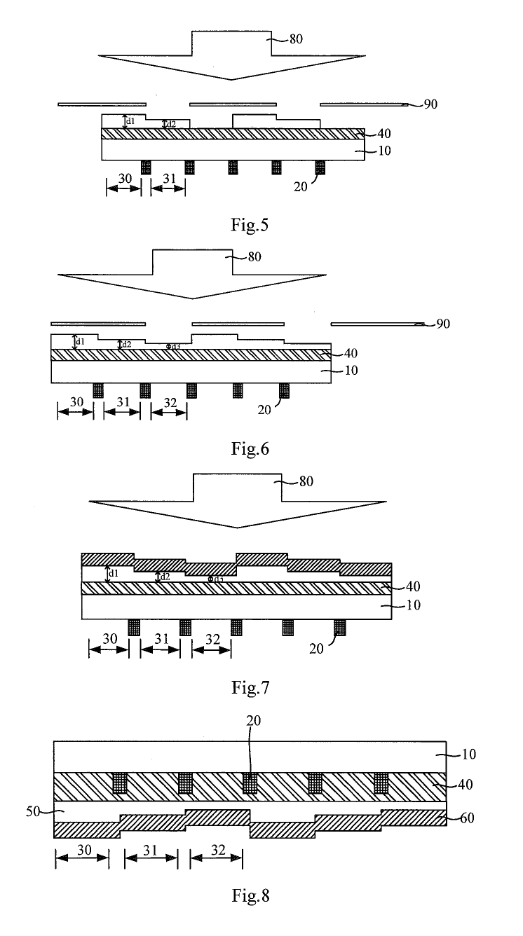

In an exemplary embodiment, as shown in FIGS. 3-7, a method for producing the color filter of FIG. 2 comprising steps of:

S100: providing a substrate on a first side of which a plurality of first pixel regions, a plurality of second pixel regions and a plurality of third pixel regions are defined;

S101: depositing a first medium sub layer 40 on the substrate 10 to cover the entire substrate 10 by a PECVD equipment 80, wherein the first medium sub layer 40 is formed to have a thickness of about 40 nm by controlling the depositing time;

S102: depositing a first medium area of the second medium sub layer 50 corresponding to the first pixel region 30 on the first medium sub layer 40 by the PECVD equipment 80 with using a mask 90, wherein the first medium area of the second medium sub layer 50 is formed to have a thickness d1 by controlling the depositing time, and the thickness d1 can be calculated by the expression (1), in an exemplary embodiment, when the second medium sub layer 50 is made of Si₃N₄, and when m=1, n=1.938, λ=700 nm, the thickness d1 is equal to 180.6 nm, in practice, the thickness d1 is allowable within a range of 180.6±15.5 nm by taking account of the manufacturing error;

S103: depositing a second medium area of the second medium sub layer 50 corresponding to the second pixel region 31 on the first medium sub layer 40 by the PECVD equipment 80 with using a mask 90, wherein the second medium area of the second medium sub layer 50 is formed to have a thickness d2 by controlling the depositing time, and the thickness d2 can be calculated by the expression (1), in an exemplary embodiment, when the second medium sub layer 50 is made of Si₃N₄, and when m=1, n=1.938, λ=546.1 nm, the thickness d2 is equal to 140.9 nm, in practice, the thickness d2 is allowable within a range of 140.9±15.5 nm by taking account of the manufacturing error;

S104: depositing a third medium area of the second medium sub layer 50 corresponding to the third pixel region 32 on the first medium sub layer 40 by the PECVD equipment 80 with using a mask 90, wherein the third medium area of the second medium sub layer 50 is formed to have a thickness d3 by controlling the depositing time, and the thickness d3 can be calculated by the expression (1), in an exemplary embodiment, when the second medium sub layer 50 is made of Si₃N₄, and when m=1, n=1.938, λ=435.8 nm, the thickness d3 is equal to 112.4 nm, in practice, the thickness d3 is allowable within a range of 112.4±15.5 nm by taking account of the manufacturing error;

S105: depositing a third medium sub layer 60 on the second medium sub layer 50 having the first, second and third medium areas to cover the entire substrate 10 by the PEVCD equipment 80, wherein the third medium sub layer 60 is formed to having a thickness of 40 nm by controlling the depositing time.

Please be noted that the sequence of the steps of S102, S103 and S104 can be arbitrarily changed as long as the medium areas have different thicknesses.

In principle, a method for producing the color filter according to the second embodiment in which the band pass filter layer 100 and the black matrix unit 20 both are formed on the same side of the substrate 10 is similar to the method for producing the color filter according to the first embodiment in which the band pass filter layer 100 and the black matrix unit 20 are formed respectively on opposite sides of the substrate 10, therefore, the method for producing the color filter according to the second embodiment is omitted herein.

When the liquid crystal display achieves the colorful image display not based on three primary colors (Red, Green and Blue), for example, based on four colors (White or Yellow is further added in addition to Red, Green and Blue), the liquid crystal display further comprises a White sub pixel or a Blue sub pixel. In this case, it is necessary to add only an additional pixel region, and a fourth medium area of the second medium sub layer 50 corresponding to the additional pixel region has a fourth thickness d4, and the fourth medium area permits only White (or Blue) light to be transmitted therethrough, and reflects light having a wave length beyond that of White (or Blue) light. In an exemplary embodiment, as for the liquid crystal display achieving the colorful image display not based on three primary colors, it is only necessary to change the thickness of the medium area of the second medium sub layer 50 corresponding to the respective pixel region, so as to permit light having the respective wave length to be transmitted through the medium area, and reflect light having a wave length beyond the respective wave length.

Similar to the color filter in prior arts, the color filter of the present invention is provided with a spacer thereon. As for the liquid crystal display, when assembling the color filter and the array substrate, the spacer is located at a side proximal to the array substrate, so as to form a certain space between the color filter and the array substrate. Liquid crystal is filled in the space to form a liquid crystal layer.

According to another aspect of the present invention, there is provided a display apparatus comprising the color filter according to the above embodiments. The display apparatus can increase the utilization of the light and improve the color resolution and quality of the image display.

In an exemplary embodiment, the display apparatus may comprise any product or member with a display function, such as, a liquid crystal display panel, a mobile telephone, a panel computer, a TV, a notebook computer, a digital photo frame, a navigator, and so on.

As shown in FIGS. 8-9, the liquid crystal display comprises the color filter according to the above embodiments, the array substrate 101 assembled together with the color filter, and the liquid layer 103 provided between the color filter and the array substrate 101.

As shown in FIG. 9, as for the liquid crystal display of an ADS type, the band pass filter layer of the color filter and the liquid crystal layer 103 are formed on opposite sides of the substrate 10, respectively. In this case, the first medium sub layer 40 of the color filter may be used as the electromagnetic shielding layer to remove the static electricity.

As shown in FIG. 10, as for the liquid crystal display of a TN type, the band pass filter layer of the color filter and the liquid crystal layer 103 are formed on the same side of the substrate 10. In this case, the third medium sub layer 60 may be used as the common electrode, and the first medium sub layer 40 may be used as the electromagnetic shielding layer to remove the static electricity.

In the above embodiments of the present invention, the color filter filters the light with the band pass filter layer of a fabryperot type, thereby, the light beam having not been transmitted through is reflected back to be utilized again, increasing the utilization of the light of the display. Furthermore, the band pass of the color filter is very narrow, improving the color resolution and quality of the image display.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle, so that more kinds of color filter can be achieved with overcoming the technical problem of the present invention.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A color filter, comprising:
a substrate;
a plurality of first pixel regions, a plurality of second pixel regions and a plurality of third pixel regions defined on a first side of the substrate; and
a band pass filter layer comprising a first medium sub layer, a second medium sub layer and a third medium sub layer successively formed on a second side of the substrate or on the plurality of first pixel regions, the plurality of second pixel regions and the plurality of third pixel regions,
wherein the second medium sub layer has a first thickness in a first medium area corresponding to the first pixel region, a second thickness in a second medium area corresponding to the second pixel region and a third thickness in a third medium area corresponding to the third pixel region.

2. The color filter according to claim 1,
wherein the band pass filter layer transmits a red light and reflects a light beam having a wavelength different from that of the red light in the first medium area;
wherein the band pass filter layer transmits a green light and reflects a light beam having a wavelength different from that of the green light in the second medium area; and
wherein the band pass filter layer transmits a blue light and reflects a light beam having a wavelength different from that of the blue light in the third medium area.

3. The color filter according to claim 1,
wherein the color filter comprises a black matrix formed on the substrate, and the first, second and third pixel regions are separated from each other by the black matrix.

4. The color filter according to claim 1,
wherein the first medium sub layer and the third medium sub layer are made of the same material.

5. The color filter according to claim 4,
wherein the first medium sub layer and the third medium sub layer are made of metal, alloy or metallic oxide; and
wherein the second medium sub layer is made of a dielectric material.

6. The color filter according to claim 5,
wherein the first medium sub layer and the third medium sub layer are made of silver, silver alloy, Indium Tin Oxid or Indium Zinc Oxide; and
wherein the second medium sub layer is made of at least one of MgF₂, SiO₂, Si₃N₄ and TiO₂.

7. The color filter according to claim 5,
wherein the first medium sub layer and the third medium sub layer have the same thickness.

8. The color filter according to claim 7,
wherein the thickness of the first medium sub layer and the third medium sub layer is in a range of 20 nm˜100 nm.

9. A display apparatus comprising a color filter according to claim 1.

10. A method for producing a color filter, comprising:
providing a substrate on a first side of which a plurality of first pixel regions, a plurality of second pixel regions and a plurality of third pixel regions are defined;
forming a first medium sub layer on a second side of the substrate or on the plurality of first pixel regions, the plurality of second pixel regions and the plurality of third pixel regions;
forming a second medium sub layer on the first medium sub layer, wherein the second medium sub layer has a first medium area, a second medium area and a third medium area corresponding to the first pixel region, the second pixel region and the third pixel region, respectively, and the first, second and third medium areas are different from each other in thickness; and
forming a third medium sub layer on the second medium sub layer having the first, second and third medium areas.

11. The method according to claim 10,
wherein the color filter comprises a black matrix formed on the substrate, and the first, second and third pixel regions are separated from each other by the black matrix.

12. The method according to claim 10,
wherein the first medium area has a thickness in a range of 180.6±15.5 nm so as to permit only a red light to be transmitted therethrough;
wherein the second medium area has a thickness in a range of 140.9±15.5 nm so as to permit only a green light to be transmitted therethrough; and
wherein the third medium area has a thickness in a range of 112.4±15.5 nm so as to permit only a blue light to be transmitted therethrough.

13. The method according to claim 10,
wherein the first medium sub layer and the third medium sub layer are made of the same material.

14. The method according to claim 10,
wherein the first medium sub layer and the third medium sub layer are made of metal, alloy or metallic oxide; and
wherein the second medium sub layer is made of a dielectric material.

15. The method according to claim 14,
wherein the first medium sub layer and the third medium sub layer are made of silver, silver alloy, Indium Tin Oxid or Indium Zinc Oxide; and
wherein the second medium sub layer is made of at least one of MgF₂, SiO₂, Si₃N₄ and TiO₂.
